(19) United States
(12) Patent Application Publication
(10) Pub. No.: US 2026/0227232 A1
(43) Pub. Date: Aug. 6, 2026

(54) ACOUSTIC PROCESSING DEVICE, ACOUSTIC PROCESSING METHOD, AND NON-TRANSITORY COMPUTER-READABLE MEDIUM

(71) Applicant: NEC Corporation, Tokyo (JP)

(72) Inventors: Noriyuki TONAMI, Tokyo (JP); Yumi ARAI, Tokyo (JP); Sakiko MISHIMA, Tokyo (JP); Reishi KONDO, Tokyo (JP); Tomoyuki HINO, Tokyo (JP)

(73) Assignee: NEC Corporation, Tokyo (JP)

(21) Appl. No.: 19/454,524

(22) Filed: Jan. 21, 2026

(30) Foreign Application Priority Data
Feb. 4, 2025 (JP) 2025-016495

(51) Int. Cl. G01H 9/00; G10L 21/0232

(52) U.S. Cl. CPC G01H 9/004; G10L 21/0232

(57) ABSTRACT

An acoustic processing device according to the present disclosure includes at least one memory configured to store an instruction group, and at least one processor configured to execute the instruction group to, separate a first acoustic signal and a second acoustic signal from a noisy acoustic signal acquired by optical fiber sensing and on which noise is superimposed using a separation technique in which same residual component is included in each signal after the separation, and generate a noise suppressed acoustic signal in which noise is suppressed from the noisy acoustic signal using the residual components included in the first acoustic signal and the second acoustic signal, and output the generated noise suppressed acoustic signal.

### INCORPORATION BY REFERENCE

This application is based upon and claims the benefit of priority from Japanese patent application No. 2025-016495, filed on Feb. 4, 2025, the disclosure of which is incorporated herein in its entirety by reference.

### TECHNICAL FIELD

The present disclosure relates to an acoustic processing device, an acoustic processing method, and a non-transitory computer-readable medium.

### BACKGROUND ART

Optical fiber sensing typified by Distributed Acoustic Sensing (DAS) can detect, for example, sound generated at a point along an optical fiber cable (e.g., Japanese Patent Application Laid-Open No. 2008-175746).

In recent years, there has also been proposed a technique of acquiring an acoustic signal indicating a sound generated at a point along an optical fiber cable and detected by optical fiber sensing, and recognizing an event such as an abnormality generated at the point along the optical fiber cable based on the acquired acoustic signal.

### SUMMARY

However, an acoustic signal acquired by optical fiber sensing is a noisy acoustic signal on which noise is superimposed, unlike an acoustic signal acquired by a microphone or the like. The noise superimposed on the noisy acoustic signal includes white noise (optical noise) and laying environmental noise (spike noise) caused by shaking or impact of the optical fiber cable.

Therefore, in order to use the noisy acoustic signal acquired by optical fiber sensing for a technique of recognizing an event or the like, it is necessary to suppress the noise of the noisy acoustic signal.

Therefore, in view of the above-described problems, an example object of the present disclosure is to provide an acoustic processing device, an acoustic processing method, and a non-transitory computer-readable medium capable of suppressing noise of a noisy acoustic signal acquired by optical fiber sensing.

An acoustic processing device according to one example aspect includes,
at least one memory configured to store an instruction group, and
at least one processor configured to execute the instruction group to,
separate a first acoustic signal and a second acoustic signal from a noisy acoustic signal acquired by optical fiber sensing and on which noise is superimposed using a separation technique in which same residual component is included in each signal after the separation, and
generate a noise suppressed acoustic signal in which noise is suppressed from the noisy acoustic signal using the residual components included in the first acoustic signal and the second acoustic signal, and output the generated noise suppressed acoustic signal.

An acoustic processing method according to one example aspect is
an acoustic processing method executed by an acoustic processing device, the method including,
separating a first acoustic signal and a second acoustic signal from a noisy acoustic signal acquired by optical fiber sensing and on which noise is superimposed using a separation technique in which same residual component is included in each signal after the separation, and
generating a noise suppressed acoustic signal in which noise is suppressed from the noisy acoustic signal using the residual components included in the first acoustic signal and the second acoustic signal, and outputting the generated noise suppressed acoustic signal.

A non-transitory computer-readable medium according to one example aspect stores a program for causing a computer to execute,
a procedure of separating a first acoustic signal and a second acoustic signal from a noisy acoustic signal acquired by optical fiber sensing and on which noise is superimposed using a separation technique in which same residual component is included in each signal after the separation, and
a procedure of generating a noise suppressed acoustic signal in which noise is suppressed from the noisy acoustic signal using the residual components included in the first acoustic signal and the second acoustic signal, and outputting the generated noise suppressed acoustic signal.

According to the above-described aspects, an acoustic processing device, an acoustic processing method, and a non-transitory computer-readable medium capable of suppressing noise of a noisy acoustic signal acquired by optical fiber sensing can be provided.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a block diagram illustrating a configuration example of an acoustic processing device according to the present disclosure;

FIG. 2 is a diagram describing an operation example of the acoustic processing device according to the present disclosure;

FIG. 3 is a flowchart describing a flow of an operation example illustrated in FIG. 2;

FIG. 4 is a diagram specifically describing an operation example illustrated in FIG. 2;

FIG. 5 is a block diagram illustrating a configuration example of the acoustic processing device according to the present disclosure; and

FIG. 6 is a block diagram illustrating a hardware configuration example of a computer that implements the acoustic processing device according to the present disclosure.

### EXAMPLE EMBODIMENT

Hereinafter, example embodiments of the present disclosure are described below with reference to the drawings. The following description and drawings are omitted and simplified as appropriate for clarity of description. In the following drawings, the same elements will be denoted by the same reference signs, and redundant description will be omitted as necessary.

### First Example Embodiment

First, two related technologies used in the present disclosure will be described.

### (1) Spectral Subtraction (SS) Technology

The SS technology is a technology for suppressing noise of a signal to be analyzed, and is a technology for subtracting a noise spectrum from a spectrum of the signal to be analyzed.

However, the SS technology has a disadvantage that a signal containing only noise is required for deriving a noise spectrum.

### (2) Harmonic-Percussive Sound Separation (HPSS) Technology

The HPSS technology is a technology developed in the field of music information processing, and is a technology for separating a harmonic component and a percussive sound component from one mixed sound. Here, the harmonic component is an acoustic component generated from a stringed instrument typified by a guitar. In addition, the percussive sound component is an acoustic component generated from a percussion instrument typified by a drum.

However, the HPSS technology has a disadvantage that acoustic components that do not have features of harmonic components and percussive sound components cannot be processed, and such acoustic components are included as the same residual component in both the harmonic components and the percussive sound components separated from the mixed sound. Here, the residual component is, for example, white noise.

In an example of the present disclosure, by combining the SS technology and the HPSS technology described above and utilizing the disadvantages of the HPSS technology, the disadvantages of the SS technology are resolved while suppressing noise of a noisy acoustic signal acquired by optical fiber sensing.

Subsequently, a configuration of an acoustic processing device 10 according to the present disclosure will be described.

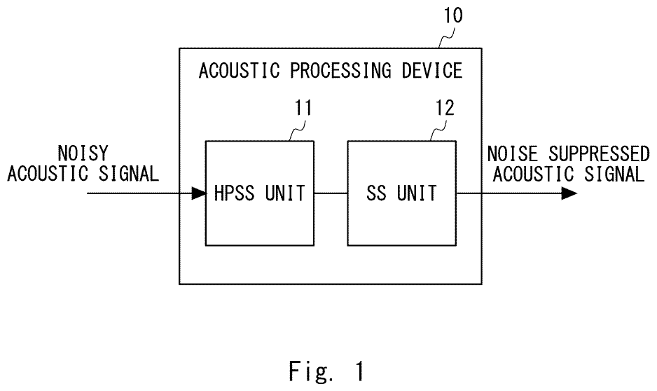

FIG. 1 is a block diagram illustrating a configuration example of an acoustic processing device 10 according to the present disclosure.

As illustrated in FIG. 1, the acoustic processing device 10 is a device that inputs a noisy acoustic signal acquired by optical fiber sensing and outputs a noise suppressed acoustic signal in which noise is suppressed from the input noisy acoustic signal.

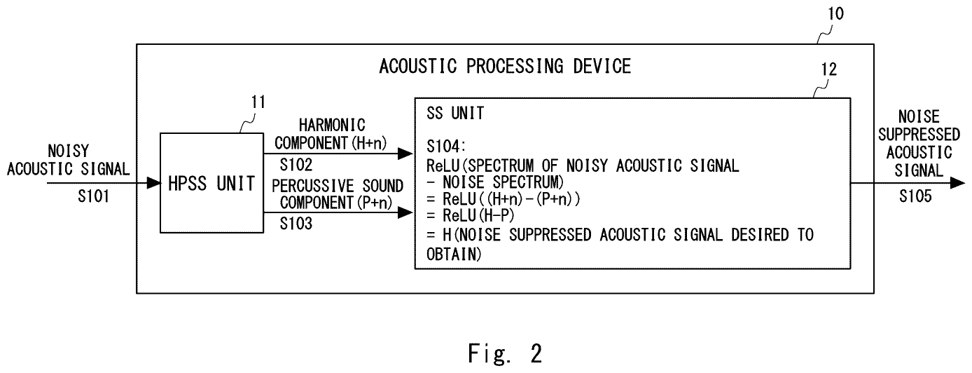

In addition, the acoustic processing device 10 includes an HPSS unit 11 and an SS unit 12. The operations of the HPSS unit 11 and the SS unit 12 will be described in the following description with reference to FIGS. 2 to 4.

Next, an operation of the acoustic processing device 10 according to the present disclosure will be described.

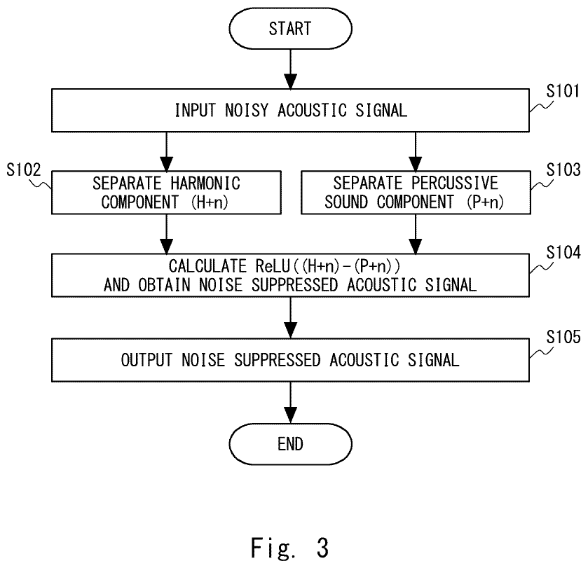

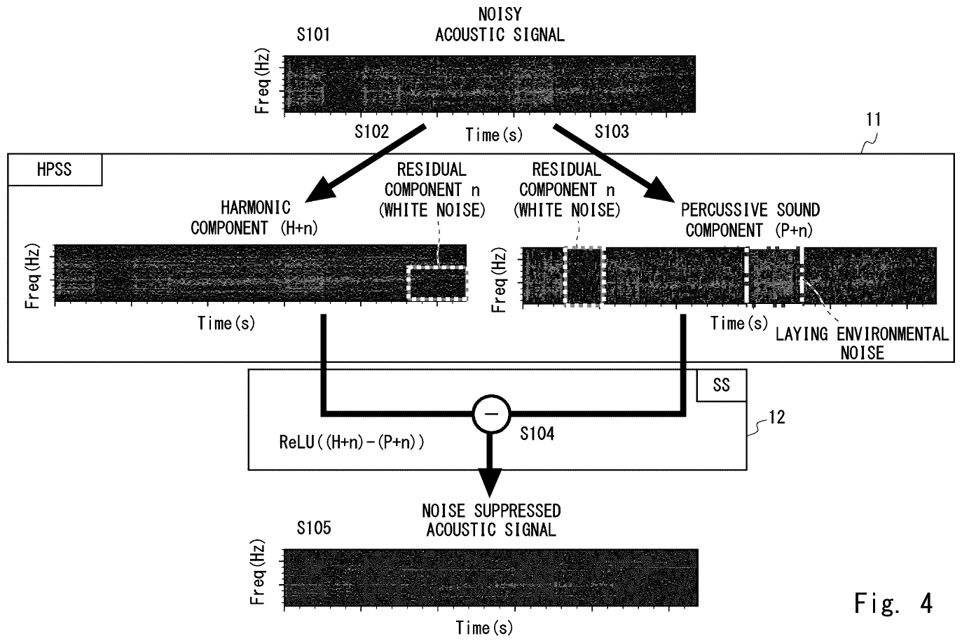

FIG. 2 is a diagram describing an operation example of the acoustic processing device 10 according to the present disclosure. FIG. 3 is a flowchart describing a flow of an operation example illustrated in FIG. 2. FIG. 4 is a diagram specifically describing an operation example illustrated in FIG. 2. In FIGS. 2 to 4, the same processing is denoted by the same reference numeral (step number).

Here, it is assumed that a sensing device (not illustrated) detects sound generated at a point on an optical fiber cable by optical fiber sensing using the optical fiber cable, indicates the detected sound, and acquires a noisy acoustic signal having noise superimposed thereon. Furthermore, the sensing device (not illustrated) is assumed to be achieved by, for example, a DAS device that performs DAS.

As illustrated in FIGS. 2 to 4, first, the HPSS unit 11 inputs a noisy acoustic signal acquired by optical fiber sensing from a sensing device (not illustrated) (step S101).

Here, FIG. 4 illustrates a spectrum of the noisy acoustic signal. The spectrum of the noisy acoustic signal illustrated in FIG. 4 corresponds to a frequency domain signal obtained by Fourier-transforming a time domain signal indicating a temporal change in the intensity of the sound generated at a point on the optical fiber cable, where the horizontal axis indicates time, and the vertical axis indicates frequency.

The HPSS unit 11 may receive a spectrum of the noisy acoustic signal illustrated in FIG. 4 from a sensing device (not illustrated). Alternatively, the HPSS unit 11 may receive the above-described time domain signal as a noisy acoustic signal from a sensing device (not illustrated) and perform Fourier transformation on the signal to obtain a spectrum of the noisy acoustic signal illustrated in FIG. 4.

Next, the HPSS unit 11 separates the spectrum of the harmonic component (step S102) and separates the spectrum of the percussive sound component (step S103) from the spectrum of the noisy acoustic signal using the HPSS technology.

Here, the spectrum of the harmonic component includes not only the harmonic component (H) but also a residual component (n) corresponding to white noise. Therefore, hereinafter, the harmonic component is referred to as a harmonic component (H+n).

In addition, the spectrum of the percussive sound component includes the percussive sound component (P) corresponding to the laying environmental noise and also includes the residual component (n) corresponding to the white noise. Therefore, hereinafter, the percussive sound component is referred to as a percussive sound component (P+n).

Next, the SS unit 12 performs SS processing by using the spectrum of the harmonic component (H+n) and the spectrum of the percussive sound component (P+n).

The SS processing is processing of subtracting the noise spectrum from the spectrum of the noisy acoustic signal. Alternatively, the SS processing is processing including processing of subtracting the noise spectrum from the spectrum of the noisy acoustic signal and processing of performing ReLU operation with respect to the subtraction result. ReLU is an operation of replacing a negative value with 0 (zero).

Here, the spectrum of the harmonic component (H+n) includes a residual component (n) corresponding to white noise. Therefore, the spectrum of the harmonic component (H+n) can be regarded as the spectrum of the noisy acoustic signal.

In addition, the spectrum of the percussive sound component (P+n) includes the percussive sound component (P) corresponding to the laying environmental noise and the residual component (n) corresponding to the white noise. Therefore, the spectrum of the percussive sound component (P+n) can be regarded as a noise spectrum.

Therefore, the SS unit 12 regards the spectrum of the harmonic component (H+n) as the spectrum of the noisy acoustic signal, regards the spectrum of the percussive sound component (P+n) as the noise spectrum, and performs the following SS processing (step S104).

ReLU (spectrum of noisy acoustic signal-noise spectrum)=ReLU ((H+n)−(P+n))

This is calculated as follows.
ReLU ((H+n)−(P+n))=ReLU (H−P)=H

That is, first, the SS unit 12 subtracts the spectrum of the percussive sound component (P+n) from the spectrum of the harmonic component (H+n). As a result, a spectrum of the acoustic component (H−P) is obtained.

Next, the SS unit 12 performs a ReLU operation on the spectrum of the acoustic component (H−P). As a result, a spectrum of the acoustic component (H) is obtained. The spectrum of the acoustic component (H) is obtained by suppressing the residual component (n) from the spectrum of the harmonic component (H+n) that is the noisy acoustic signal. Therefore, the acoustic component (H) corresponds to a noise suppressed acoustic signal in which noise is suppressed from the noisy acoustic signal.

In this way, the SS unit 12 can obtain the acoustic component (H) as the noise suppressed acoustic signal by the above-described SS processing.

Thereafter, the SS unit 12 outputs the noise suppressed acoustic signal (acoustic component (H)) obtained by the above-described SS processing (step S105). Specifically, the SS unit 12 outputs a spectrum of the noise suppressed acoustic signal (acoustic component (H)).

As described above, according to the first example embodiment, the HPSS unit 11 uses the HPSS technology to separate the spectrum of the harmonic component and the spectrum of the percussive sound component from the spectrum of the noisy acoustic signal acquired by optical fiber sensing. At this time, both the spectrum of the harmonic component and the spectrum of the percussive sound component include the same residual component (white noise). Therefore, the SS unit 12 uses the residual component to generate a noise suppressed acoustic signal in which noise is suppressed from the noisy acoustic signal. Specifically, the SS unit 12 subtracts the spectrum of the percussive sound component from the spectrum of the harmonic component and replaces the negative value of the spectrum after the subtraction with 0 (zero) to obtain the noise suppressed acoustic signal. As a result, it is possible to suppress noise of the noisy acoustic signal acquired by optical fiber sensing.

Furthermore, according to the first example embodiment, since the spectrum of the percussive sound component includes the percussive sound component corresponding to the laying environmental noise and the residual component corresponding to the white noise, the spectrum of the percussive sound component can be regarded as a noise spectrum. Therefore, unlike the SS technology of the related art, an acoustic signal including only noise for deriving a noise spectrum is unnecessary.

### Second Example Embodiment

A second example embodiment corresponds to an example embodiment that is a superordinate concept of the first example embodiment described above.

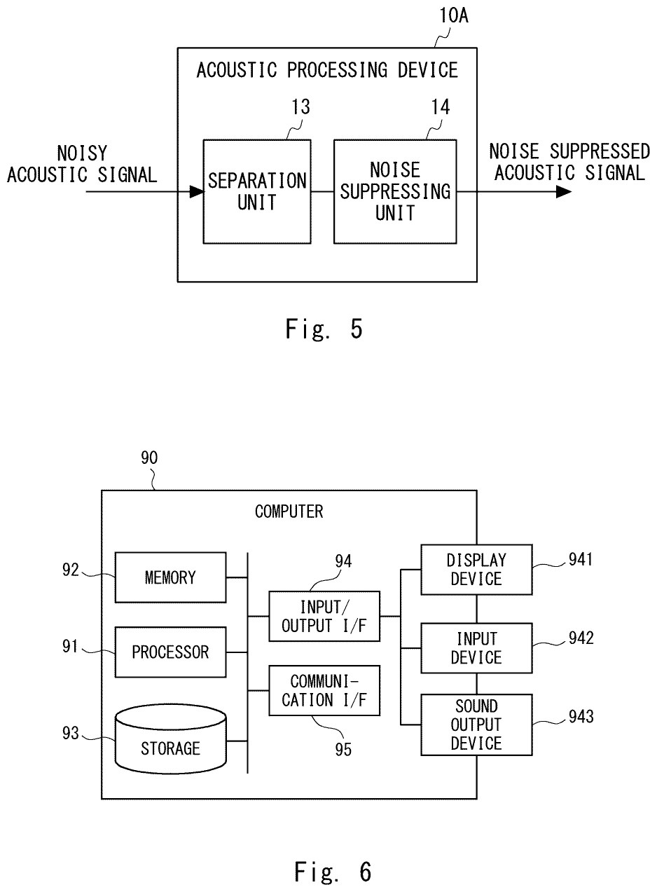

FIG. 5 is a block diagram illustrating a configuration example of an acoustic processing device 10A according to the present disclosure.

As illustrated in FIG. 5, the acoustic processing device 10A includes a separation unit 13 and a noise suppressing unit 14.

The separation unit 13 separates the first acoustic signal and the second acoustic signal from the noisy acoustic signal acquired by optical fiber sensing and on which noise is superimposed, using a separation technique in which the same residual component is included in each signal after the separation. The separation unit 13 corresponds to the HPSS unit 11.

The noise suppressing unit 14 uses the residual components included in the first acoustic signal and the second acoustic signal to generate a noise suppressed acoustic signal in which noise is suppressed from the noisy acoustic signal, and outputs the generated noise suppressed acoustic signal. The noise suppressing unit 14 corresponds to the SS unit 12.

As a result, it is possible to suppress noise of the noisy acoustic signal acquired by optical fiber sensing.

The separation technique may be a technique of separating the harmonic component and the percussive sound component from the mixed sound. Furthermore, the separation unit 13 may separate the first acoustic signal including the harmonic component and the residual component and the second acoustic signal including the percussive sound component and the residual component from the noisy acoustic signal using the separation technique.

Furthermore, the separation unit 13 may separate the spectrum of the first acoustic signal and the spectrum of the second acoustic signal from the spectrum of the noisy acoustic signal using the separation technique. Furthermore, the noise suppressing unit 14 may subtract the spectrum of the second acoustic signal from the spectrum of the first acoustic signal, replace the negative value of the spectrum after the subtraction with zero, and obtain the spectrum after the replacement as the spectrum of the noise suppressed acoustic signal.

Furthermore, the separation technique may be a Harmonic-Percussive Sound Separation (HPSS) technique. In addition, the optical fiber sensing may be Distributed Acoustic Sensing (DAS).

### Other Example Embodiments

In the first and second example embodiments described above, the plurality of components (HPSS unit 11 and SS unit 12, or separation unit 13 and noise suppressing unit) are provided in the acoustic processing devices 10 and 10A, but the present disclosure is not limited thereto. In the present disclosure, the plurality of components may be provided in a plurality of devices in a distributed manner. That is, the present disclosure may be achieved by a system including a plurality of devices.

### Hardware Configuration of Acoustic Processing Device According to Example Embodiment

FIG. 6 is a block diagram illustrating a hardware configuration example of a computer 90 that implements the acoustic processing devices 10 and 10A according to the present disclosure.

As illustrated in FIG. 6, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a Central Processing Unit (CPU) or a Graphics Processing Unit (GPU). The memory 92 is, for example, a memory such as a Random Access Memory (RAM) or a Read Only Memory (ROM). The storage 93 is, for example, a storage device such as a Hard Disk Drive (HDD), a Solid State Drive (SSD), or a memory card. The storage 93 may be a memory such as the RAM or the ROM.

A program is stored in the storage 93. This program includes an instruction group (or software code) for causing the computer 90 to perform one or more functions in the above-described acoustic processing devices 10 and 10A upon read by the computer. The components in the above-described acoustic processing devices 10 and 10A may be implemented by the processor 91 reading and executing a program stored in the storage 93. Furthermore, the storage function in the acoustic processing devices 10 and 10A described above may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, and the like. The display device 941 is a device that displays a screen corresponding to drawing data processed by the processor 91, such as a Liquid Crystal Display (LCD), a Cathode Ray Tube (CRT) display, or a monitor. The input device 942 is a device that receives operator's operation input, and is, for example, a keyboard, a mouse, a touch sensor, or the like. The display device 941 and the input device 942 may be integrated and implemented as a touch panel. The sound output device 943 is a device that acoustically outputs a sound corresponding to acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An acoustic processing device including,
at least one memory configured to store an instruction group, and
at least one processor configured to execute the instruction group to,
separate a first acoustic signal and a second acoustic signal from a noisy acoustic signal acquired by optical fiber sensing and on which noise is superimposed using a separation technique in which same residual component is included in each signal after the separation, and
generate a noise suppressed acoustic signal in which noise is suppressed from the noisy acoustic signal using the residual components included in the first acoustic signal and the second acoustic signal, and output the generated noise suppressed acoustic signal.

### Supplementary Note 2

The acoustic processing device according to supplementary note 1, in which
the separation technique is a technique of separating a harmonic component and a percussive sound component from a mixed sound, and
the at least one processor is configured to execute the instruction group to separate the first acoustic signal, including the harmonic component and the residual component, and the second acoustic signal, including the percussive sound component and the residual component, from the noisy acoustic signal using the separation technique.

### Supplementary Note 3

The acoustic processing device according to supplementary note 2, in which the separation technique is a Harmonic-Percussive Sound Separation (HPSS) technique.

### Supplementary Note 4

The acoustic processing device according to supplementary note 2, in which the at least one processor is configured to execute the instruction group to
separate a spectrum of the first acoustic signal and a spectrum of the second acoustic signal from a spectrum of the noisy acoustic signal using the separation technique,
subtract the spectrum of the second acoustic signal from the spectrum of the first acoustic signal,
replace a negative value of the spectrum after the subtraction with zero, and
obtain the spectrum after the replacement as a spectrum of the noise suppressed acoustic signal.

### Supplementary Note 5

The acoustic processing device according to supplementary note 1, in which the optical fiber sensing is Distributed Acoustic Sensing (DAS).

### Supplementary Note 6

An acoustic processing method executed by an acoustic processing device, the method including,
separating a first acoustic signal and a second acoustic signal from a noisy acoustic signal acquired by optical fiber sensing and on which noise is superimposed using a separation technique in which same residual component is included in each signal after the separation, and
generating a noise suppressed acoustic signal in which noise is suppressed from the noisy acoustic signal using the residual components included in the first acoustic signal and the second acoustic signal, and outputting the generated noise suppressed acoustic signal.

### Supplementary Note 7

A non-transitory computer-readable medium storing a program for causing a computer to execute,
a procedure of separating a first acoustic signal and a second acoustic signal from a noisy acoustic signal acquired by optical fiber sensing and on which noise is superimposed using a separation technique in which same residual component is included in each signal after the separation, and
a procedure of generating a noise suppressed acoustic signal in which noise is suppressed from the noisy acoustic signal using the residual components included in the first acoustic signal and the second acoustic signal, and outputting the generated noise suppressed acoustic signal.

Note that, some or all of elements (e.g., structures and functions) specified in Supplementary Notes 2 to 5 dependent on Supplementary Note 1 may also be dependent on Supplementary Note 6 and Supplementary Note 7 in dependency similar to that of Supplementary Notes 2 to 5 dependent on Supplementary Note 1. Some or all of elements specified in any of Supplementary Notes may be applied to various types of hardware, software, and recording means for recording software, systems, and methods.

What is claimed is:

1. An acoustic processing device comprising:
at least one memory configured to store an instruction group; and
at least one processor configured to execute the instruction group to,
separate a first acoustic signal and a second acoustic signal from a noisy acoustic signal acquired by optical fiber sensing and on which noise is superimposed using a separation technique in which same residual component is included in each signal after the separation, and
generate a noise suppressed acoustic signal in which noise is suppressed from the noisy acoustic signal using the residual components included in the first acoustic signal and the second acoustic signal, and output the generated noise suppressed acoustic signal.

2. The acoustic processing device according to claim 1, wherein
the separation technique is a technique of separating a harmonic component and a percussive sound component from a mixed sound, and
the at least one processor is configured to execute the instruction group to separate the first acoustic signal, including the harmonic component and the residual component, and the second acoustic signal, including the percussive sound component and the residual component, from the noisy acoustic signal using the separation technique.

3. The acoustic processing device according to claim 2, wherein the separation technique is a Harmonic-Percussive Sound Separation (HPSS) technique.

4. The acoustic processing device according to claim 2, wherein the at least one processor is configured to execute the instruction group to,
separate a spectrum of the first acoustic signal and a spectrum of the second acoustic signal from a spectrum of the noisy acoustic signal using the separation technique;
subtract the spectrum of the second acoustic signal from the spectrum of the first acoustic signal;
replace a negative value of the spectrum after the subtraction with zero; and
obtain the spectrum after the replacement as a spectrum of the noise suppressed acoustic signal.

5. The acoustic processing device according to claim 1, wherein the optical fiber sensing is Distributed Acoustic Sensing (DAS).

6. An acoustic processing method executed by an acoustic processing device, the method comprising:
separating a first acoustic signal and a second acoustic signal from a noisy acoustic signal acquired by optical fiber sensing and on which noise is superimposed using a separation technique in which same residual component is included in each signal after the separation, and
generating a noise suppressed acoustic signal in which noise is suppressed from the noisy acoustic signal using the residual components included in the first acoustic signal and the second acoustic signal, and outputting the generated noise suppressed acoustic signal.

7. A non-transitory computer-readable medium storing a program for causing a computer to execute,
a procedure of separating a first acoustic signal and a second acoustic signal from a noisy acoustic signal acquired by optical fiber sensing and on which noise is superimposed using a separation technique in which same residual component is included in each signal after the separation, and
a procedure of generating a noise suppressed acoustic signal in which noise is suppressed from the noisy acoustic signal using the residual components included in the first acoustic signal and the second acoustic signal, and outputting the generated noise suppressed acoustic signal.
